(19) United States
(12) Patent Application Publication
(10) Pub. No.: US 2015/0128489 A1
(43) Pub. Date: May 14, 2015

(54) PLANT GROWING SYSTEM

(71) Applicant: PANASONIC INTELLECTUAL PROPERTY MANAGEMENT CO., LTD., Osaka (JP)

(72) Inventors: Makoto YAMADA, Osaka (JP); Masaki ISHIWATA, Osaka (JP); Shinichi AOKI, Osaka (JP); Kyohei NAKAMURA, Kyoto (JP)

(73) Assignee: PANASONIC INTELLECTUAL PROPERTY MANAGEMENT CO., LTD., Osaka (JP)

(21) Appl. No.: 14/533,586

(22) Filed: Nov. 5, 2014

(30) Foreign Application Priority Data
Nov. 13, 2013 (JP) 2013-234544

(51) Int. Cl. A01G 7/04

(52) U.S. Cl. CPC A01G 7/045
USPC 47/58.1 LS

(57) ABSTRACT

In a plant growing system, a first light source irradiates a plant with light having a peak wavelength in a range from 380 to 560 nm and a peak wavelength in a range from 560 to 680 nm and a second light source irradiates the plant with far-red light having a peak wavelength in a range from 685 to 780 nm. Further, a control unit controls the first and the second light source to perform respective irradiation operations and a time setting unit sets a first and a second time zone in which the control unit controls the first and the second light source to perform the respective irradiation operations. The first time zone ranges from a first predetermined time before sunset to a second predetermined time after sunset, and the second time zone starts after the first light source completes its irradiation operation.

### CROSS-REFERENCE TO RELATED APPLICATIONS

This application claims priority to Japanese Patent Application No. 2013-234544 filed on Nov. 13, 2013, the entire contents of which are incorporated herein by reference.

### TECHNICAL FIELD

The present disclosure relates to a plant growing system for controlling growth of plants.

### BACKGROUND ART

Conventionally, there is known a plant growing method in which growth of a plant is controlled by irradiating light emitted from an artificial light source to the plant. As one example, there is known a method in which a plant is subjected to a short-day-treatment by irradiating mixed light of red light and far-red light to the plant at the beginning and/or the end of a photophase in a photoperiod of the plant (see, e.g., Japanese Unexamined Patent Application Publication No. 2009-136155).

As another example, there is known a method in which at least one of red light and far-red light is irradiated to a solanaceous plant (particularly, tomato) for 1 to 3 hours after sunset in order to obtain high sugar tomato (see, e.g., Japanese Unexamined Patent Application Publication No. 2007-282544).

However, the method disclosed in Japanese Unexamined Patent Application Publication No. 2009-136155 does not necessarily promote the growth of the plant, although they accelerate the bloom time of the plant. Further, this method does not take into account the flower bud differentiation of the plant. Moreover, it is difficult for a worker to visually recognize the plant, which may lead to lower work efficiency.

The method disclosed in Japanese Unexamined Patent Application Publication No. 2007-282544 does not necessarily promote the growth of the plant, although it increases the sugar content of the plant. Further, this method is limited to a solanaceous plant, but cannot be necessarily applied to other plants. Moreover, this method also does not take into account the flower bud differentiation of the plant. In addition, it is difficult for a worker to visually recognize the plant, which may lead to lower work efficiency.

### SUMMARY OF THE INVENTION

In view of the above, the present disclosure provides a plant growing system capable of efficiently promoting the growth of a plant (crop) without largely affecting the flower bud differentiation and capable of improving the visibility of a plant and eventually increasing the work efficiency.

In accordance with one aspect of the present invention, there is provided a plant growing system, including: a first light source configured to irradiate a plant with light having a peak wavelength in a range from 380 nm to 560 nm and a peak wavelength in a range from 560 nm to 680 nm; a second light source configured to irradiate the plant with far-red light having a peak wavelength in a range from 685 nm to 780 nm; a control unit configured to control the first light source light source and the second light source to perform respective irradiation operations; and a time setting unit configured to set a first time zone in which the control unit controls the first light source to perform its irradiation operation and a second time zone in which the control unit controls the second light source to perform its irradiation operation. The first time zone ranges from a first predetermined time before sunset to a second predetermined time after sunset, and the second time zone starts after the first light source completes its irradiation operation.

Further, the second predetermined time may be 2 hours after sunset.

Further, the second time zone may start as soon as the first light source completes its irradiation operation.

Further, the first light source and the second light source may be accommodated in a single case.

Further, the second light source emits far-red light with an irradiance of 0.02 W/m² or more and an integrated irradiance per day of 0.2 kJ/m² or more.

With such configuration, the plant is irradiated with the light emitted from the first light source in the time zone, which ranges from a first predetermined time before sunset to a second predetermined time after sunset. Thereafter, the plant is irradiated with the far-red light emitted from the second light source. This makes it possible to efficiently promote the growth of the plant without largely affecting the flower bud differentiation of the plant. Moreover, the plant is irradiated with the light having a wavelength ranging from 380 nm to 560 nm. Therefore, as compared with a case where the plant is irradiated with only red light and/or far-red light, it is possible to improve the visibility of the plant and to increase the work efficiency.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1 shows a configuration of a plant growing system according to one embodiment of the present invention.

FIG. 2 shows spectral characteristics of lights emitted from a first light source and a second light source used in the plant growing system.

FIG. 3 is a perspective view showing the first light source and the second light source accommodated in a single case.

FIG. 4 is a side view showing an arrangement of the first light source and the second light source with respect to a plant.

FIG. 5 is a plane view showing the arrangement of the first light source and the second light source with respect to the plant.

FIG. 6 is a view showing a light irradiation pattern of the first light source and the second light source in an example utilizing the plant growing system.

### DETAILED DESCRIPTION

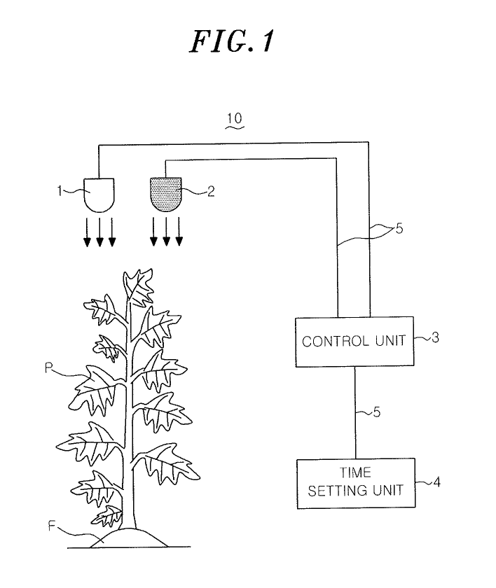

A plant growing system according to one embodiment of the present invention will now be described with reference to FIGS. 1 to 6. The present plant growing system is designed to promote growth of a plant (particularly, a flowering plant) in the facility cultivation such as a fully-closed plant seedling production system, an agricultural vinyl greenhouse or a glass greenhouse, or in the outdoor cultivation.

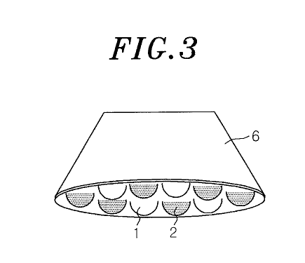

As shown in FIG. 1, the plant growing system 10 includes a first light source 1, a second light source 2, a control unit 3 configured to control the first and the second light source 1 and 2 to perform respective irradiation operations, and a time setting unit 4 configured to set time zones in which the control unit 3 controls the first and the second light source 1 and 2 to perform the respective irradiation operations. The control unit 3 is electrically connected to the first light source 1, the second light source 2 and the time setting unit 4 through respective power lines 5. The first and the second light source 1 and 2 are collectively accommodated in a single case (see, e.g., FIG. 3), so that a plant P planted in a ridge F is irradiated with lights emitted from the first and the second light source 1 and 2.

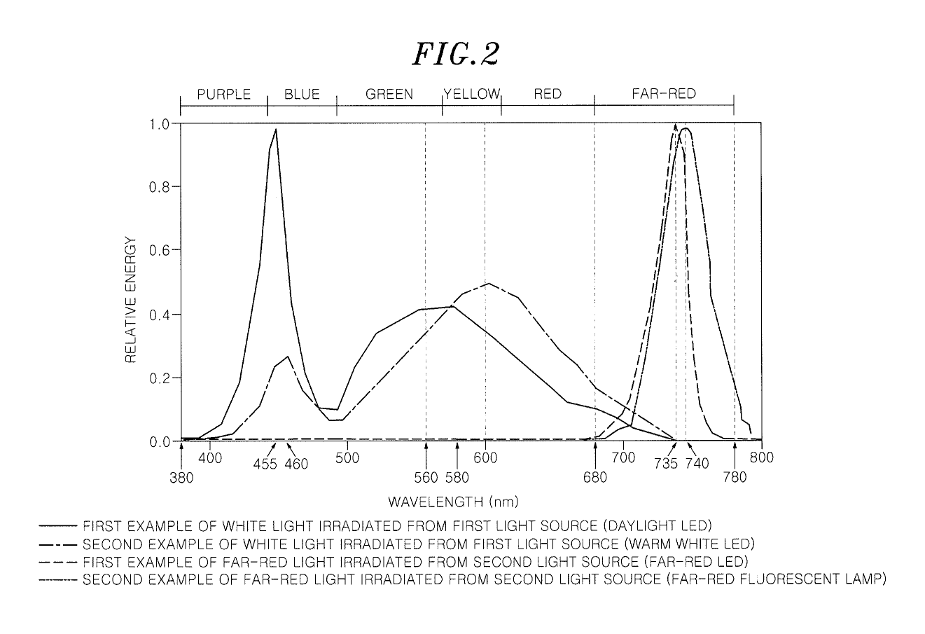

As shown in FIG. 2, the light emitted from the first light source 1 (indicated by a solid line and a single-dot chain line) has a peak wavelength in a range from 380 nm to 560 nm and a peak wavelength in a range from 560 nm to 680 nm. In case where the first light source 1 is formed of a daylight LED, the first light source 1 emits, e.g., daylight white light (indicated by a solid line) which includes blue light having a peak wavelength at about 455 nm and green-yellow-red light having a peak wavelength at about 580 nm. In case where the first light source 1 is formed of a warm white LED, the first light source 1 emits, e.g., warm white light (indicated by a single-dot chain line) which includes blue light having a peak wavelength at about 460 nm and green-yellow-red light having a peak wavelength at about 600 nm. The first light source 1 is not limited to the daylight LED or the warm white LED but may be formed of, e.g., a HID lamp (such as a high-pressure sodium lamp, a xenon lamp or the like), or a cool white fluorescent lamp or an incandescent lamp combined with a cutoff filter that cuts off light having a wavelength of 680 nm or more.

The light emitted from the second light source 2 (indicated by a broken line and a double-dot chain line) is the far-red light having a peak wavelength in a range from 685 nm to 780 nm. In case where the second light source 2 is formed of a far-red LED, the second light source 2 emits, e.g., light (indicated by a broken line) having a peak wavelength at about 735 nm. In case where the second light source 2 is formed of a far-red fluorescent lamp, the second light source 2 emits, e.g., light (indicated by a double-dot chain line) having a peak wavelength at about 740 nm. The second light source 2 is not limited to the far-red LED or the far-red fluorescent lamp but may be formed of, e.g., a far-red EL element, a HID lamp, or an incandescent lamp combined with a transmission filter that transmits light having a wavelength of 685 nm or more.

Preferably, the first light source 1 irradiates light around the plant P at an irradiance of 0.01 W/m² or more. In case where the first light source 1 is formed of the daylight LED, the ratio of the irradiance of light having a wavelength ranging from 380 nm to 579 nm to the irradiance of light having a wavelength ranging from 580 nm to 680 nm becomes approximately 3:1. In case where the first light source 1 is formed of the warm white LED, the ratio becomes approximately 1:1. Preferably, the second light source 2 irradiates light around the plant P at an irradiance of 0.02 W/m² or more and with an integrated irradiance per day of 0.2 kJ/m² or more. The irradiance may be measured by using a light meter “Li-250” and a sensor “Li-200SA”, both of which are manufactured by Leica.

Referring back to FIG. 1, the control unit 3 has a microcomputer, a relay, a switch, and the like. Further, the control unit 3 includes a dimmer for adjusting the irradiance of the light emitted from each of the first and the second light source 1 and 2. The dimmer includes, e.g., a light controller and electrically controls the irradiance of the light emitted from each of the first and the second light source 1 and 2.

The time setting unit 4 includes a timer, a microcomputer, and the like. The time setting unit 4 sets, based on a preset time inputted by a user, a time zone for each of the first and the second light source 1 and 2 to perform the corresponding irradiation operation. Specifically, the time setting unit 4 sets a first and a second times zone such that the first light source 1 performs its irradiation operation in the first time zone, which ranges from a first predetermined time (e.g., 1 hour) before sunset up to a second predetermined time (e.g., 2 hours) after sunset, and such that the second light source 2 performs its irradiation operation for 3 hours or more in the second time zone after the irradiation operation of the first light source 1 is completed. That is to say, the time setting unit 4 is configured to set a first time zone in which the control unit controls the first light source 1 to perform its irradiation operation and a second time zone in which the control unit controls the second light source 2 to perform its irradiation operation. Further, the first time zone ranges from a first predetermined time before sunset to a second predetermined time after sunset, and the second time zone starts after the first light source completes its irradiation operation. In examples to be described later, the time setting unit 4 sets the second time zone such that the second light source 2 starts its irradiation operation as soon as the irradiation operation of the first light source 1 is completed. However, a time interval of about 30 minutes may exist between the light irradiation from the first light source 1 and the light irradiation from the second light source 2.

The time setting unit 4 may include a photo-sensor to detect the intensity of sunlight (natural light), so that the irradiation timing of the first light source 1 may be determined by detecting the brightness around the plant P with the photo-sensor. Moreover, the time setting unit 4 may include a solar-time switch which stores the sunset times for one year. In this case, the irradiation timing of the first light source 1 may be determined based on the sunset times stored in the solar-time switch. In the illustrated example, the time setting unit 4 is installed independently of the control unit 3. However, the time setting unit 4 may be included in the control unit 3.

As shown in FIG. 3, the first light source 1 and the second light source 2 are alternately arranged in plural while being accommodated in a single case 6. The case 6 is made of, e.g., a metal such as aluminum, stainless steel or the like, which is a material having high heat conductivity, superior heat dissipation and high light reflectivity.

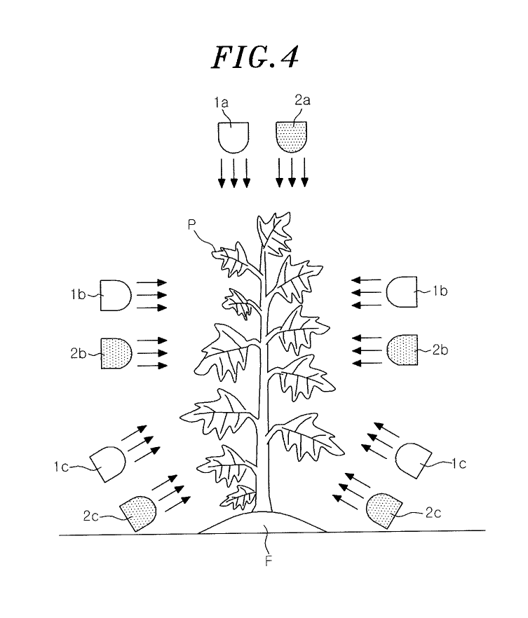

In general, the first and the second light source 1 and 2 are arranged above the plant P. However, if the plant P is tall and/or has a large number of branches and/or leaves, the lower side or the interior of the plant P cannot be irradiated with a sufficient amount of light emitted merely from the first and the second light source 1 and 2 arranged above the plant P. Thus, as shown in FIG. 4, in addition to the first and the second light source 1 and 2 arranged above the plant P (hereinafter referred to as “upper light sources 1a and 2a), additional first and second light sources 1 and 2 may be arranged at the lateral side and the lower side of the plant P. The first and the second light source 1 and 2 arranged at the lateral side (hereinafter referred to as “lateral light sources 1b and 2b”) and the first and the second light source 1 and 2 arranged at the lower side (hereinafter referred to as “lower light sources 1c and 2c”) are configured such that the attachment angles thereof can be adjustable so as to irradiate light at desire angles. By arranging the first and the second light sources in the above manner, the lower side or the interior of the plant P can be irradiated with a sufficient amount of light even if the plant P is tall and/or has a large number of branches and leaves.

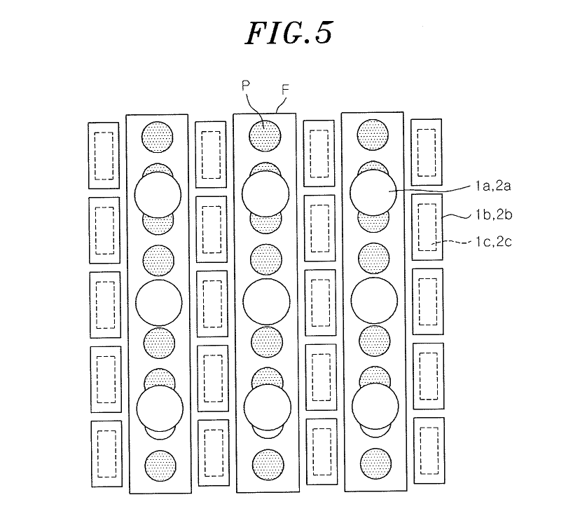

FIG. 5 is a top view showing the arrangement of the upper light sources 1a and 2a, the lateral light sources 1b and 2b and the lower light sources 1c and 2c with respect to the plant P. In the illustrated example, the upper light sources 1a and 2a, the lateral light sources 1b and 2b and the lower light sources 1c and 2c are respectively shown as a single member. The upper light sources 1a and 2a are disposed in multiple numbers at a regular interval along the extension direction of the ridges F (the arrangement direction of the plants P). The lateral light sources 1b and 2b are subjected to a waterproof treatment by being covered with a cylinder or the like and are disposed in multiple numbers between the ridges F at a regular interval along the extension direction of the ridges F. The lower light sources 1c and 2c are subjected to a waterproof treatment in the same manner as the lateral light sources 1b and 2b and are disposed in multiple numbers on the ground surface between the ridges F at a regular interval along the extension direction of the ridges F. The lateral light sources 1b and 2b and the lower light sources 1c and 2c may be configured by a continuum light source such as hollow-light-guide-type illumination instruments, an optical fiber, an elongated EL device or the like.

The turn-on and light distribution of the upper light sources 1a and 2a, the lateral light sources 1b and 2b and the lower light sources 1c and 2c are controlled depending on the growth of the plant P. For example, if the plant P is still small (the beginning of a growth stage), the upper light sources 1a and 2a, far away from the plant P, are turned off and the lateral light sources 1b and 2b and the lower light sources 1c and 2c, near the plant P, are turned on. At this time, the attachment angles of the lateral light sources 1b and 2b and the lower light sources 1c and 2c are adjusted to make the light distributions narrow, so that the plant P is intensively irradiated with focused light. Further, the plant P at the beginning of the growth stage is not fully developed in branch and leave, so that the light irradiated to the plant P can reach all over the plant P even if the amount of light is small. Therefore, the lateral light sources 1b and 2b and the lower light sources 1c and 2c may be controlled to irradiate a decreased amount of light.

On the other hand, if the plant P has grown enough, all of the upper light sources 1a and 2a, the lateral light sources 1b and 2b and the lower light sources 1c and 2c are turned on. At this time, the attachment angles of the lateral light sources 1b and 2b and the lower light sources 1c and 2c are adjusted to make the light distributions wider, so that a wider range of the plant P is irradiated with the light. Further, the fully developed plant P has a lot of branches and leaves, so that the light irradiated to the plant P may not reach every corner of the plant P if the light amount is not enough. Therefore, it is preferred to increase the amount of light irradiated from the upper light sources 1a and 2a, the lateral light sources 1b and 2b and the lower light sources 1c and 2c.

The effects given to the growth of the plant P by the plant growing system 10 configured as above were examined by actually cultivating a chrysanthemum (cultivar: Seyprinse) with the plant growing system 10. Growth promoting effect of the plant growing system 10 on the chrysanthemum were evaluated in such a way that average days required for about 90% of the chrysanthemum to have 80 cm or more stems in height. Further, the influence on the flower bud differentiation was evaluated in such a way that the flower bud differentiation is classified into three status, “not delayed”, “slightly delayed (within one day)” and “delayed two days or more”, by comparing with a case (comparative example 1 to be described later) where the chrysanthemum is cultivated only by natural light without using the plant growing system 10. In Tables 1 and 2 to be described later, the “not delayed”, the “slightly delayed” and the “delayed two days or more” in the flower bud differentiation are indicated by “⊚”, “◯” and “Δ”, respectively.

### EXAMPLES

The chrysanthemum was planted in the end of November and was cultivated up to March of the next year for about 4 months. Immediately after the planting, in order to maintain nutrition growth of the chrysanthemum, four hours discontinuation of a dark phase was carried out by lighting on an incandescent lamp at midnight until the mid-January (approximately 45 days after starting the planting, in which the chrysanthemum has a height of 20 cm or more). Thereafter, the chrysanthemum was transferred to the reproduction growth, and simultaneously the light irradiation to the chrysanthemum was started by the plant growing system 10. The light irradiation was continued until chrysanthemum bloomed.

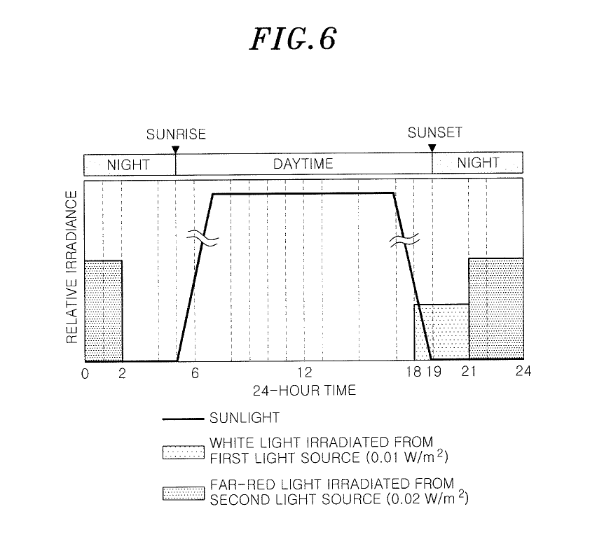

As shown in FIG. 6, in this example, the chrysanthemum was irradiated with white light emitted from the first light source 1 for 3 hours from 18:00 before sunset (19:00) to 21:00. That is to say, the chrysanthemum was irradiated with the white light emitted from the first light source 1 for 1 hour together with the sunlight and was irradiated for 2 hours after sunset without the sunlight. Thereafter, the chrysanthemum was irradiated with far-red light emitted from the second light source 2 for 5 hours from 21:00 to 2:00 by switching the first light source 1 to the second light source 2.

The white light emitted from the first light source 1 was irradiated at an irradiance of 0.01 W/m². The far-red light emitted from the second light source 2 was irradiated at an irradiance of 0.02 W/m². The first light source 1 was formed of the daylight LED (example 1) or the warm white LED (example 2) described above with reference to FIG. 2. The first light source 1 was disposed above the chrysanthemum (the plant P) at a density of 20 pieces/m². The second light source 2 was formed of the far-red LED described above with reference to FIG. 2. The second light source 2 was disposed above the chrysanthemum at a density of 20 pieces/m².

As shown in Table 1, in the example 1, the chrysanthemum was irradiated with the daylight white light emitted from the first light source 1 and continuously irradiated with the far-red light emitted from the second light source 2. In this case, only 75 days were required, on average, for the chrysanthemum to have 80 cm stems in height. The flower bud differentiation was slightly delayed (within 1 day). In the example 2, the chrysanthemum was irradiated with the warm white light emitted from the first light source 1 and continuously irradiated with the far-red light emitted from the second light source 2. In this case, only 77 days were required, on average, for the chrysanthemum to have 80 cm stems in height. The flower bud differentiation was slightly delayed.

TABLE 1
Growth Promoting Effect and Influence
on Flower Bud Differentiation

| | Average days | | |
|---|---|---|---|
| | required for | | Influence on |
| | chrysanthemum | | flower bud |
| | to have 80 cm | | differentia- |
| Subject | stems in height | | tion |
| Example 1: daylight white light | 75 | days | ◯ |
| (0.01 W/m²) + far-red light | | | |
| (0.02 W/m²) | | | |
| Example 2: warm white light | 77 | days | ◯ |
| (0.01 W/m²) + far-red light | | | |
| (0.02 W/m²) | | | |
| Comparative example 1: natural | 103 | days | ⊚ |
| light only | | | |
| Comparative example 2: daylight | 102 | days | Δ |
| white light | | | |
| (0.01 W/m²) only | | | |
| Comparative example 3: far-red | 91 | days | ◯ |
| light (0.02 W/m²) only | | | |
| Comparative example 4: red | 81 | days | ◯ |
| light (0.01 W/m²) + far-red | | | |
| light (0.02 W/m²) | | | |

⊚: As compared with comparative example 1, the flower bud differentiation is not delayed.
◯: As compared with comparative example 1, the flower bud differentiation is slightly delayed (within 1 day).
Δ: As compared with comparative example 1, the flower bud differentiation is delayed 2 days or more.

In contrast, in the comparative example 1, the chrysanthemum was cultivated with natural light only without using the plant growing system 10. In this case, 103 days were required, on average, for the chrysanthemum to have 80 cm stems in height. The comparison result of the examples 1 and 2 with the comparative example 1 shows that the plant growing system 10 can efficiently promote the growth of the chrysanthemum without largely affecting the flower bud differentiation of chrysanthemum.

Further, in a comparative example 2, the chrysanthemum was irradiated only with the daylight white light emitted from the first light source 1 for 3 hours from 18:00 to 21:00. In this case, 102 days were required, on average, for the chrysanthemum to have 80 cm stems in height. The flower bud differentiation was delayed 2 days or more. This result shows that the growth of the chrysanthemum cannot be promoted by the daylight white light alone and further that the flower bud differentiation of chrysanthemum is significantly delayed. Further, in a comparative example 3, the chrysanthemum was irradiated only with the far-red light emitted from the second light source 2 for 5 hours from 21:00 to 2:00. In this case, 91 days were required, on average, for the chrysanthemum to have 80 cm stems in height. The flower bud differentiation was slightly delayed. This result shows that the growth of the chrysanthemum can be somewhat promoted with the far-red light but the growth promoting effect is inferior to those of the examples 1 and 2. Accordingly, it was found that the white light irradiation by the first light source 1 and the far-red light irradiation by the second light source 2 are both needed in order to efficiently promote the growth of the chrysanthemum without largely affecting the flower bud differentiation. Furthermore, it was also found that the continuous transfer from the white light irradiation to the far-red light irradiation gives better result.

Further, in a comparative example 4, instead of the white light emitted from the first light source 1, the chrysanthemum was irradiated with red light having a wavelength ranging from 610 nm to 680 nm for 3 hours from 18:00 to 21:00 at an irradiance of 0.01 W/m². Then, the chrysanthemum was irradiated with the far-red light emitted from the second light source 2 for 5 hours from 21:00 to 2:00. In this case, 81 days were required, on average, for the chrysanthemum to have 80 cm stems in height. The flower bud differentiation was slightly delayed. This result shows that the growth of the chrysanthemum can be somewhat promoted by the continuous irradiation of the red light and the far-red light, but it was found that the continuous irradiation of the white light and the far-red light gives better result in efficiently promoting the growth of chrysanthemum. The growth promoting effect on chrysanthemum is greatest in order from the combination of the daylight white light and the far-red light, the combination of the warm white light and the far-red light, and the combination of the red light and the far-red light (i.e., red light+far-red light<warm white light+far-red light<daylight white light+far-red light). This indicates that the growth of the chrysanthemum can be more efficiently promoted as the light contains a larger amount of light component (e.g., blue light component) which shows a greater difference in contrast from the far-red light.

As shown in Table 2, there is an example 3, which is basically same as the example 1 except that an irradiance of the daylight white light emitted from the first light source 1 was set to 0.08 W/m². In this case, only 74 days were required, on average, for the chrysanthemum to have 80 cm stems in height. The flower bud differentiation was slightly delayed.

TABLE 2
Growth Promoting Effect and Influence
on Flower Bud Differentiation

| | | |
|---|---|---|
| | Average days | |
| | required for | Influence on |
| | chrysanthemum | flower bud |
| | to have 80 cm | differentia- |
| Subject | stems in height | tion |

| | | | |
|---|---|---|---|
| Example 3: daylight white light | 74 | days | ◯ |
| (0.08 W/m²) + far-red light | | | |
| (0.02 W/m²) | | | |
| Comparative example 5: | 104 | days | Δ |
| daylight white light | | | |
| (0.08 W/m²) only | | | |
| Comparative example 6: red | 79 | days | ◯ |
| light (0.08 W/m²) + far-red | | | |
| light (0.02 W/m²) | | | |

⊚: As compared with comparative example 1, the flower bud differentiation is not delayed.
◯: As compared with comparative example 1, the flower bud differentiation is slightly delayed (within 1 day).
Δ; As compared with comparative example 1, the flower bud differentiation is delayed 2 days or more.

In contrast, in a comparative example 5, the chrysanthemum was irradiated only with the daylight white light emitted from the first light source 1 for 3 hours from 18:00 to 21:00 at an irradiance of 0.08 W/m². In this case, 104 days were required, on average, for the chrysanthemum to have 80 cm stems in height. The flower bud differentiation was delayed 2 days or more. In a comparative example 6, instead of the white light emitted from the first light source 1, the chrysanthemum was irradiated with red light for 3 hours from 18:00 to 21:00 at an irradiance of 0.08 W/m². Then, the chrysanthemum was irradiated with the far-red light emitted from the second light source 2 for 5 hours from 21:00 to 2:00. In this case, 79 days were required, on average, for the chrysanthemum to have 80 cm stems in height. The flower bud differentiation was slightly delayed. From the above result, it was found that, even when the irradiance of the white light is increased, the continuous transfer from the white light irradiation by the first light source 1 to the far-red light irradiation by the second light source 2 gives better result in promoting the growth of chrysanthemum as described in the examples 1 and 2.

According to the plant growing system 10, the plant P is irradiated with the light having a peak wavelength in a range from 380 nm to 560 nm and a peak wavelength in a range from 560 nm to 680 nm in the time zone, which, e.g., ranges up to 2 hours after sunset from before sunset. Thereafter, the plant P is irradiated with the far-red light. As a result, it is possible to efficiently promote the growth of the plant P without largely affecting the flower bud differentiation of the plant P (chrysanthemum). This makes it possible to shorten the cultivation cycle of the plant P and to increase the number of plants P harvested within a specified time period. Moreover, the plant P is irradiated with the light having a wavelength ranging from 380 nm to 560 nm. Therefore, as compared with a case where the plant P is irradiated only with the red light and/or the far-red light, it is possible to improve the visibility of the plant P, thereby increasing the work efficiency. It is also possible to promote photosynthesis, consequently making the form of the plant P better.

Though the plant growing system 10 described above is applicable throughout the year, it is effective particularly in a short-day term, i.e., from the autumn to the beginning of spring, in which the natural light (sunlight) decreases. In case where the plant growing system 10 is employed in a fully-closed plant production factory on which the sunlight is not irradiated, the first light source 1 and the second light source 2 is on/off controlled based on, e.g., a photophase/dark phase schedule of an artificial light source used in cultivating the plant P.

The plant growing system according to the present disclosure is not limited to the embodiment and the examples described above but may be modified in many different forms. For example, the first light source and the second light source may be realized by controlling the wavelength of the light emitted from one light source. As an example, an incandescent lamp which emits visible light of any wavelength may be used as a light source and may be suitably combined with a cutoff filter that interrupts light having a wavelength of 680 nm or more, or a transmission filter that transmits light having a wavelength of 685 nm or more.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A plant growing system, comprising:
a first light source configured to irradiate a plant with light having a peak wavelength in a range from 380 nm to 560 nm and a peak wavelength in a range from 560 nm to 680 nm;
a second light source configured to irradiate the plant with far-red light having a peak wavelength in a range from 685 nm to 780 nm;
a control unit configured to control the first light source and the second light source to perform respective irradiation operations; and
a time setting unit configured to set a first time zone in which the control unit controls the first light source to perform its irradiation operation and a second time zone in which the control unit controls the second light source to perform its irradiation operation,
wherein the first time zone ranges from a first predetermined time before sunset to a second predetermined time after sunset, and the second time zone starts after the first light source completes its irradiation operation.

2. The plant growing system of claim 1, wherein the second predetermined time is 2 hours after sunset.

3. The plant growing system of claim 1, wherein the second time zone starts as soon as the first light source completes its irradiation operation.

4. The plant growing system of claim 1, wherein the first light source and the second light source are accommodated in a single case.

5. The plant growing system of claim 2, wherein the first light source and the second light source are accommodated in a single case.

6. The plant growing system of claim 3, wherein the first light source and the second light source are accommodated in a single case.

7. The plant growing system of claim 1, wherein the second light source emits far-red light with an irradiance of 0.02 W/m² or more and an integrated irradiance per day of 0.2 kJ/m² or more.

8. The plant growing system of claim 2, wherein the second light source emits far-red light with an irradiance of 0.02 W/m² or more and an integrated irradiance per day of 0.2 kJ/m² or more.

9. The plant growing system of claim 3, wherein the second light source emits far-red light with an irradiance of 0.02 W/m² or more and an integrated irradiance per day of 0.2 kJ/m² or more.

10. The plant growing system of claim 4, wherein the second light source emits far-red light with an irradiance of 0.02 W/m² or more and an integrated irradiance per day of 0.2 kJ/m² or more.

11. The plant growing system of claim 5, wherein the second light source emits far-red light with an irradiance of 0.02 W/m or more and an integrated irradiance per day of 0.2 kJ/m² or more.

12. The plant growing system of claim 6, wherein the second light source emits far-red light with an irradiance of 0.02 W/m² or more and an integrated irradiance per day of 0.2 kJ/m² or more.
